(19) United States
(12) Patent Application Publication
(10) Pub. No.: US 2015/0122961 A1
(43) Pub. Date: May 7, 2015

(54) Suspended Tool Holder and Modified Tool

(71) Applicants: Stan Batiste, Granite Bay, CA (US); Maryann Batiste, Granite Bay, CA (US); Steven Achstein, Roseville, CA (US)

(72) Inventors: Stan Batiste, Granite Bay, CA (US); Maryann Batiste, Granite Bay, CA (US); Steven Achstein, Roseville, CA (US)

(21) Appl. No.: 14/508,995

(22) Filed: Oct. 7, 2014

Related U.S. Application Data
(60) Provisional application No. 61/888,416, filed on Oct. 8, 2013.
(60) Provisional application No. 61/979,943, filed on Apr. 15, 2014.

(51) Int. Cl. A47L 13/51; F16M 13/02; A47L 13/512

(52) U.S. Cl. CPC A47L 13/51; A47L 13/512; F16M 13/02
USPC 248/251; 248/200; 248/309.1; 248/309.4; 248/316.1

(57) ABSTRACT

A sponge holder includes a mount that has a mounting fixture and at least one mounting connector. The mounting connector is configured to fix the mount to a surface. The sponge holder further includes a suspension arm extending from the mounting fixture, and a connector disposed at a distal end of the suspension arm. The sponge includes an adapter, and the adapter is configured to connect with the connector of the sponge holder.

### PRIORITY CLAIM

This application is a continuation of, claims priority to and the benefit of U.S. Provisional Application No. 61/888,416 filed on Oct. 8, 2013 and to U.S. Provisional Application No. 61/979,943, filed on Apr. 15, 2014, the contents of which are hereby incorporated by reference.

### FIELD OF THE INVENTION

The disclosed embodiments relate to tool holding devices. More specifically, the disclosed embodiments relate to a tool such as a conventional kitchen sponge and an associated tool holder that is configured to hold the sponge.

### RELATED ART

Heretofore, in order to prevent a sponge or other tool or utensil such as a kitchen sponge from carrying bacteria and/or growing mold, prior designs considered the holding device independent of revising the sponge design. This art primarily uses mechanical means of support to keep portions of the sponge elevated in order to allow air to dry as much surface area as possible. Other means of decreasing organism development in a sponge include pretreatment with chemicals to inhibit their growth. These means attempt to increase the life of the sponge by decreasing organism growth slowing sponge breakdown and by eliminating odor.

Such sponge holders, however, do not adequately dry the sponge to prevent contamination because of the portions of the sponge which are supported by the holding device. Further, chemicals may be toxic to a user and may also prematurely damage the fibers in a sponge. Thus, a sponge and sponge holder that may more easily prevent contamination is desired.

### SUMMARY

The disclosed embodiments have been developed in light of the above problem and aspects of the invention may include a sponge holder comprising a mount that has a mounting fixture and at least one mounting connector. The mounting connector is configured to fix the mount to a surface. The sponge holder further includes a suspension arm extending from the mounting fixture, and a connector disposed at a distal end of the suspension arm. Further aspects of the invention include a sponge comprising an adapter. The adapter is configured to connect with the connector of the sponge holder.

The connector may further comprise a magnet housing that includes a magnet. The magnet housing is configured to allow the magnet to rotate therein. The adapter also may comprise magnetic material. Accordingly, the sponge may connect to the sponge holder by a magnetic field between the magnet and the magnetic material.

The magnetic material may be embedded inside of the sponge. As another alternative, the adapter may be a sponge modification tool. The modification tool may include a head that comprises the magnetic material and a body that is configured to be inserted into the sponge and to be retained within the sponge.

The connector may also comprise a first side of a hook and loop fastener. In this instance, the adapter may be the second side the hook and loop fastener and the adapter may be disposed on an outer side surface of the sponge. The adapter may also be a sponge modification tool that includes a head that comprises a second side of the hook and loop fastener and a body that is configured to be inserted into the sponge and to be retained within the sponge.

The connector may alternatively comprise a suspension rod that extends substantially horizontally. The adapter may also be an aperture that extends through the sponge, and the suspension rod is configured to extend through the aperture, thereby suspending the sponge from the connector. The adapter may also be a sponge modification tool. The modification tool may include a head that forms a ring, the suspension rod being configured to extend through the ring, and a body that is configured to be inserted into the sponge and to be retained within the sponge.

Other aspects of the invention may include a suspension tool holder for holding and suspending a tool comprising a mount having a mounting fixture and at least one mounting connector, the mounting connector being configured to attach the mount to a surface a suspension arm extending from the mounting fixture, the extension arm being configured to provide clearance between the mounting fixture and the suspended tool, and a connector attached to a distal end of the suspension arm, the connector configured to connect with an adapter, the adapter modifying the tool to allow the tool to be suspended therefrom.

According to some aspects, the tool may be a sponge, the connector may be a magnet housing that includes a magnet, and the adapter may be a magnetic material embedded within the sponge.

In the suspension tool holder, the connector may also be a magnet housing that includes a magnet, and the adapter may comprise a magnetic material. The connector may further be a first side of a hook and loop fastener and the adapter may include a second side of the hook and loop fastener. The connector may additionally be a suspension rod that extends horizontally, and at least part of the adapter may form a ring shape through which the suspension rod is configured to extend.

Additional aspects of the invention may include, a sponge holder configured to suspend a sponge, the sponge holder comprising a mount having a mounting fixture and at least one mounting connector, the at least one mounting connector being configured to fix the mount to a surface, a suspension arm extending from the mounting fixture, and a connector disposed at a distal end of the suspension arm. The connector may include actuators and jaws, the actuators being configured open and close the jaws and being lockable in the closed position, and the jaws being configured to grip a sponge, thereby suspending the sponge from the jaws.

In the sponge holder, the suspension arm is configured to extend from the mounting fixture so as to provide clearance between the sponge and the mounting fixture. The connector may be selectively removable from the suspension arm.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 shows a sponge holder and sponge along with an enlarged view of sponge holder sponge interface according to an exemplary embodiment of the invention.

FIG. 2 shows a modified sponge according to an exemplary embodiment of the invention.

FIG. 3 shows modification tools for modifying a sponge for use with the sponge holder shown in FIG. 1.

FIG. 4 shows an alternative sponge holder and sponge according to an exemplary embodiment of the invention.

FIG. 5 shows modification tools for modifying a sponge for use with the sponge holder shown in FIG. 4.

FIG. 6 shows an alternative sponge holder and sponge according to an exemplary embodiment of the invention.

FIG. 7 shows a modified sponge for use with the sponge holder shown in FIG. 6.

FIG. 8 shows modification tools for modifying a sponge for use with the sponge holder shown in FIG. 6.

FIG. 9 shows an alternative sponge holder, modification tool, and sponge according to an exemplary embodiment of the invention.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

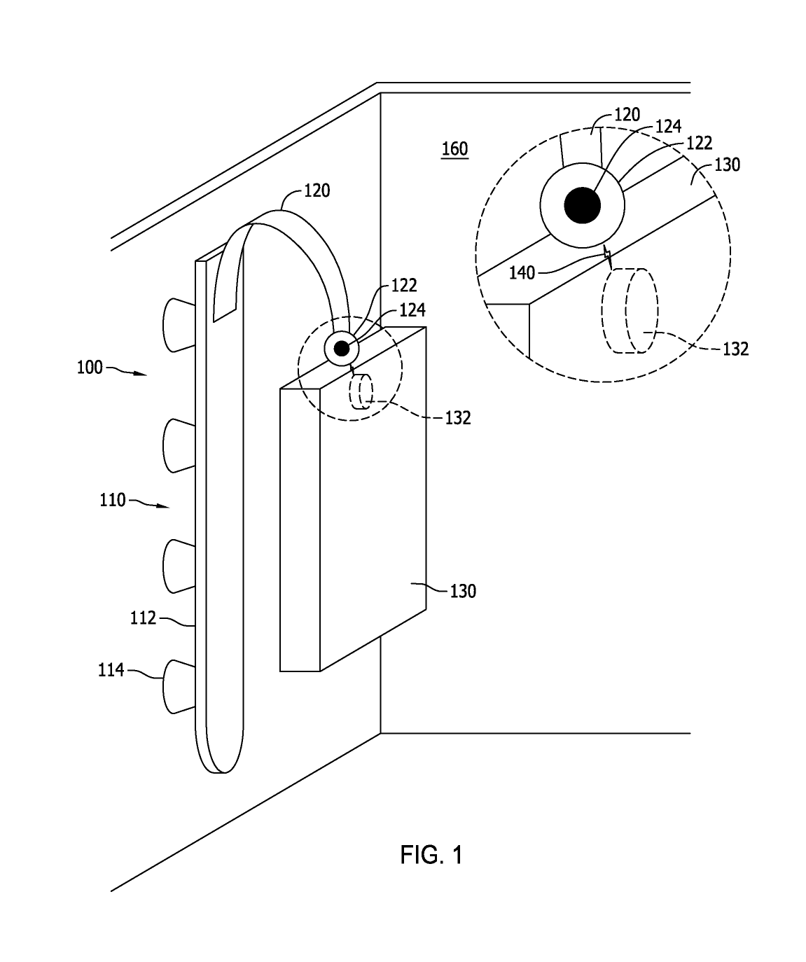

Embodiments of a suspended tool holder such as a sponge holder and an associated sponge will be described with reference to the accompanying drawings. FIG. 1 shows a sponge holder and sponge along with an enlarged view of sponge holder sponge interface according to an exemplary embodiment of the invention. In this embodiment, the sponge holder 100 includes a mount 110, a suspension arm 120, and a connector 122.

The mount 110 is configured to be attached or mounted to a surface. For example, the mount 110 may be attached to a vertical wall 160 of a kitchen sink. The mount 110 comprises a mounting fixture 112 and one or more mounting connectors 114 that are attached to the mounting fixture 112. The mounting connectors 114 are configured to attach or fix the mount 110 to a surface, such as the vertical surface 160 of the kitchen sink.

In this embodiment as shown in FIG. 1, the mounting fixture 112 is a long, rectangular member configured to be aligned vertically along the surface 160 of the sink. However, the mounting fixture 112 is not limited to this configuration. The mounting fixture 112 may be configured be aligned horizontally along the surface of the sink 160. The mounting fixture may also take the form any number of suitable shapes and sizes, such as a circular, square, a “Y” or “U” shaped configuration, and so forth.

In FIG. 1, the mounting connectors 114 are shown as suction cups configured to attach the mount 110 to the surface 160 of the sink. The suction cups 114 may be made of a flexible material that is capable of sealing the suction cups 114 against the surface 160 of the sink and holding the mounting fixture 112 in a fixed position. The mounting connectors 114 are not limited to suction cups, but may be any suitable connectors including, but not limited to, mechanical fasteners such as pins, screws, brackets, hooks, and so forth; adhesives; magnets; etc. Furthermore any suitable combination of the above described shapes for the mounting fixture 112 and connectors 114 may be utilized.

The mount 110 is configured to support the suspension arm 120. The suspension arm 120 may be connected to the mount 110 by way of mechanical fasteners, adhesives, etc. Alternatively, the suspension arm 120 may be formed integrally with the mount 110, such as through an injection molding process. The suspension arm 120 is configured to connect to and extend away from a surface of the mounting fixture 112 opposite from the surface on which the mounting connectors 114 are disposed. In this embodiment, the suspension arm 120 is shown to be in a curved shape. However, the suspension arm 120 may be shaped in any suitable manner such as having a plurality of straight portions with angles therebetween. The mount 110 may also be configured to support a plurality of suspension arms 120 for suspending multiple sponges or other tools, such as when the mount 110 is configured to be horizontal or in a “Y” or a “U” shape.

The suspension arm 120 includes a connector 122. In this embodiment, the connector 122 is a magnet housing unit that comprises a magnet 124 therein. The magnetic housing unit 122 is configured to allow the magnet 124 to rotate or otherwise orient itself to magnetically align with a corresponding magnetic object in close proximity to the magnet 124. The connector 122 may be attached to the suspension arm 120 in any suitable manner including by mechanical fasteners, snap fit, adhesives, etc. The connector 122 may also be formed integrally with the suspension arm 120.

The connector 122 facilitates connection with and suspension of a tool such as a sponge 130. The sponge 130 in this embodiment is modified with an adapter so that it may be suspended from the connector 122. In this embodiment, the sponge 130 is configured to include an adapter that is an embedded magnetic material 132. In this manner, when the sponge 130 is positioned so that the embedded magnetic material 132 is brought into a close proximity with the magnet 124 in the connector 122, the sponge 130 is suspended from the connector 122 by the magnetic field 140 between the magnet 124 and the embedded magnetic material 132.

With the above described configuration, the sponge 130 may be suspended from the connector 122 such that the sponge is held away from the surface of the sink 160. The resulting arrangement also allows the sponge to avoid contact with any supporting surfaces of either the mount 110 or the sink 160. Because of this, almost the entire surface of the sponge 130 is exposed to air drying, and the suspension of the sponge 130 allows water to drain away by gravity. Thus, this configuration allows easy storage of the sponge while decreasing organism growth and odor, thereby increasing the practical usage life of the sponge.

While in the above embodiment a sponge 130 is shown as being suspended from the suspension arm 120, the invention is not limited to this. For example, eating or cooking utensils, rags, towels, and/or other tools and cleaning items may be modified and suspended from suspension arm as described above. Furthermore, the sponge holder 100 may be configured with multiple suspension arms 120 to suspend multiple sponges, tools, and/or other items simultaneously. One skilled in the art will also appreciate that many other base and support arm designs are possible, as explained above.

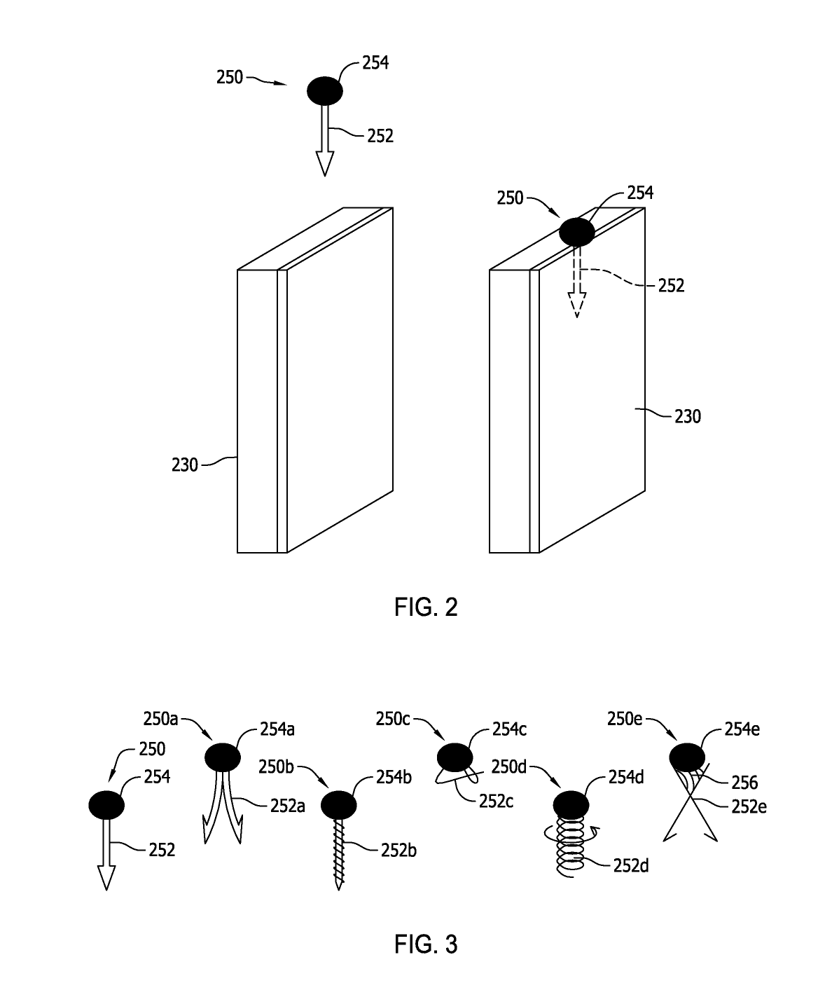

FIG. 2 shows a modified sponge according to an exemplary embodiment of the invention. In the embodiment shown in FIG. 1, the sponge 130 is constructed to include the embedded magnetic material 130 as an adapter. However, a conventional sponge 230 shown in FIG. 2 as a readily available sponge with a scouring pad may also be suspended from the connector 122. Specifically the sponge 230 may be modified by a modification tool 250 that functions as an adapter to connect to the connector 122. In FIG. 2, the modification tool 250 is a barbed tack including a head 254 comprising a magnetic material and a pointed, barbed body 252. The modification tool 250 may be inserted into the sponge 230 by pressing the body 252 into the sponge 130. The modification tool 250 is maintained within the sponge 230 by way of barbed body 252. Once the modification tool 250 is inserted into the sponge 230, the sponge 230 may be suspended from the connector 122 in the same manner as described above with reference to FIG. 1. By utilizing the modification tool 250, a conventional sponge 230 may be modified so as to be suspended from the connector 122. Thus the sponge holder 100 may be utilized to suspend not only the sponge 130 with the embedded magnetic material 132, but may also suspend the conventional sponge 230.

FIG. 3 shows modification tools for modifying a sponge for use with the sponge holder shown in FIG. 1. In addition to the modification tool 250, a number of other examples of modification tools 250a-250e may be used to modify the conventional sponge 230. Each of the modification tools 250a-250e includes a head 254a-254e comprising magnetic material for connecting with the magnet 124 of the connector 122. The body 252a-252e of each modification tool 250a-250e is configured to be inserted within and attach to the sponge 230. For example, the body 252a includes a pair of barbed pins biased away from one another. The body 252b is configured as a screw which can be twisted into the sponge 230. The body 252c is a pin and connector that is configured to pin the modification tool 250c to the sponge 230. The body 252d is a spiral pin that may be twisted into the sponge 230. Finally, the body 252e is comprised of spring loaded, barbed pins that are inserted into the sponge 230 and are spring biased away from one another via a spring 256.

The above examples of modification tools 250-250e may of course each be used in combination with the connector 122. The sponge 230 thus may be modified in a number of different ways so as to be suspended from the connector 122. Any combination of sponge 230 and modification tool 250-250e may thus be utilized to suspend the sponge 230 from the sponge holder 100.

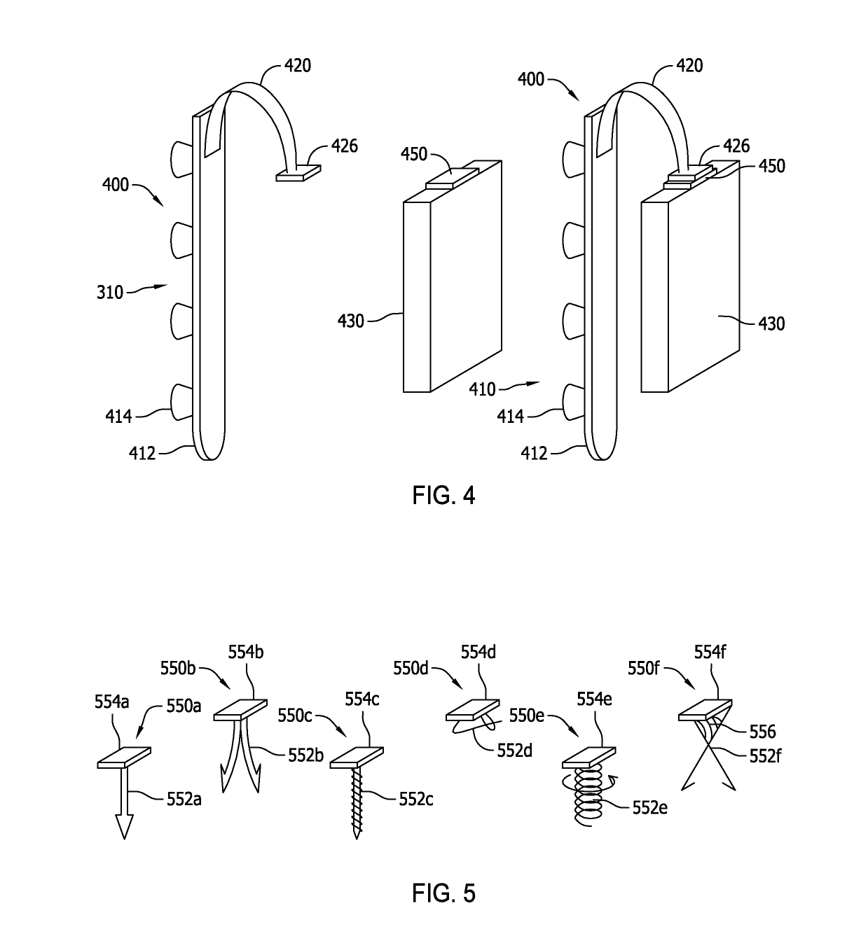

FIG. 4 shows an alternative sponge holder and sponge according to an exemplary embodiment of the invention. In this embodiment, a sponge holder 400 includes a mount 410, a mounting fixture 412, a plurality of mounting connectors 414, and a suspension arm 420. These features are substantially similar to the mount 110, the mounting fixture 112, the plurality of mounting connectors 114, and the suspension arm 120, and thus a detailed description of these features will be omitted.

The sponge holder 400 further includes a connector 426. The connector 426 in this embodiment comprises one side of a hook and loop fastener (commonly known under the trade name Velcro). The connector 426 may be attached to the suspension arm in any suitable manner including by mechanical fastening, adhesives, etc.

The sponge 430 is fitted with the other side of the hook and loop fastener 450. The hook and loop fastener 450 may be formed integrally with the sponge 430, or may be adhered or fastened to the sponge 430. With the hook and loop fastener 450, the sponge 430 may be suspended from the arm 420 via the connector 426 having the other side of the hook and loop fastener. The advantages achieved by this configuration are similar to those explained with reference to FIGS. 1-3.

FIG. 5 shows modification tools for modifying a sponge for use with the sponge holder shown in FIG. 4. The sponge 430 may be a conventional sponge which is modified by a modification tool 550a-550f. Similar to the modification tools 250-250e, the modification tools 550a-550f each have a head 554a-554f. The head 554a-554f of each modification tool 550a-550f comprises one side of a hook and loop fastener configured to be fastened to the connector 426. Each head 554a-554f is attached to a body 552a-552f that is inserted into the sponge 430. The bodies 552a-552f are substantially similar to bodies 252-252e, and thus a description thereof will be omitted.

The modification tools 550a-550f thus allow even a convention sponge to be suspended from the sponge holder 400 as shown in FIG. 4. In this manner, the practical life of the sponge 430 may be extended.

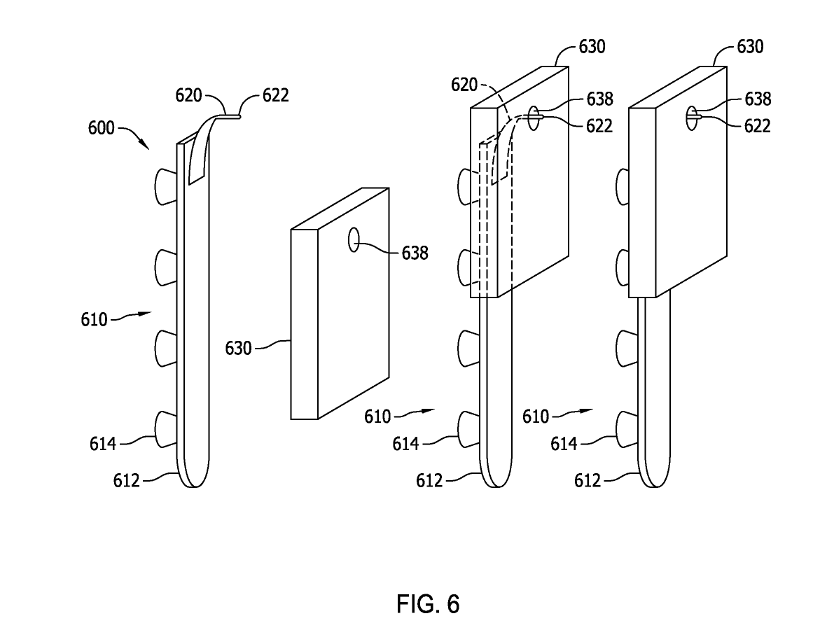

FIG. 6 shows an alternative sponge holder and sponge according to an exemplary embodiment of the invention. In this embodiment, a sponge holder 600 includes a mount 610 with a mounting fixture 612 and mounting connectors 614. The mount 610, mounting fixture 612, and mounting connectors 614 are substantially similar to mount 110, mounting fixture 112, and mounting connectors 114, and a description thereof will be omitted.

The sponge holder 600 includes a suspension arm 620. The suspension arm may be attached to the mount 610 as in the other embodiments already described. The suspension arm includes a suspension rod 622. The suspension rod 622 is a thin, cylindrical, horizontal extension of the suspension arm 620. The suspension rod 622 may have a rounded tip or may include a head or lip to maintain a sponge on the end thereof.

The sponge 630 is constructed so as to include an aperture 638 that extends through the width of the sponge 638. The aperture 638 is preferably disposed toward one of the longitudinal ends of the sponge 630. The suspension rod 622 is configured to extend through the aperture 638 so that the sponge 630 may hang from the suspension rod 622 and thus be suspended from the suspension arm 620.

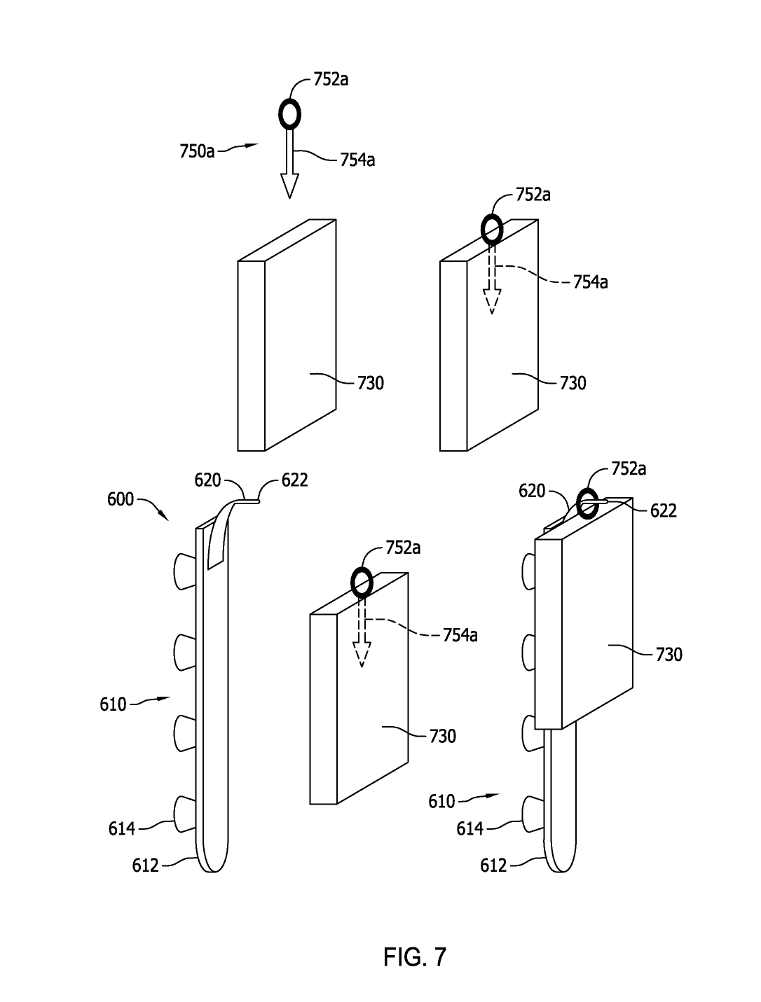

FIG. 7 shows a modified sponge for use with the sponge holder shown in FIG. 6. Here, a conventional sponge 730 is modified for use with the sponge holder 600 by way of a sponge modification tool 750a. The sponge modification tool 750a has a head 752a that is configured as a ring to receive the suspension rod 622. The modification tool 750a further includes a body 754a that is configured to be inserted in the sponge 730. The body 754a also fixes the modification tool 750a to the sponge 730. Here, the body 754a is a pointed, barbed member that may be inserted into the sponge 730 and hold its position within the sponge 730.

When the modification tool 752a is used to modify the sponge 730, the sponge 730 may be suspended from the sponge holder 600 by inserting the suspension rod 622 into and through the head 752a of the modification tool 750a. In this manner, the sponge may avoid contamination form organic growth and the practical life of the sponge may be extended.

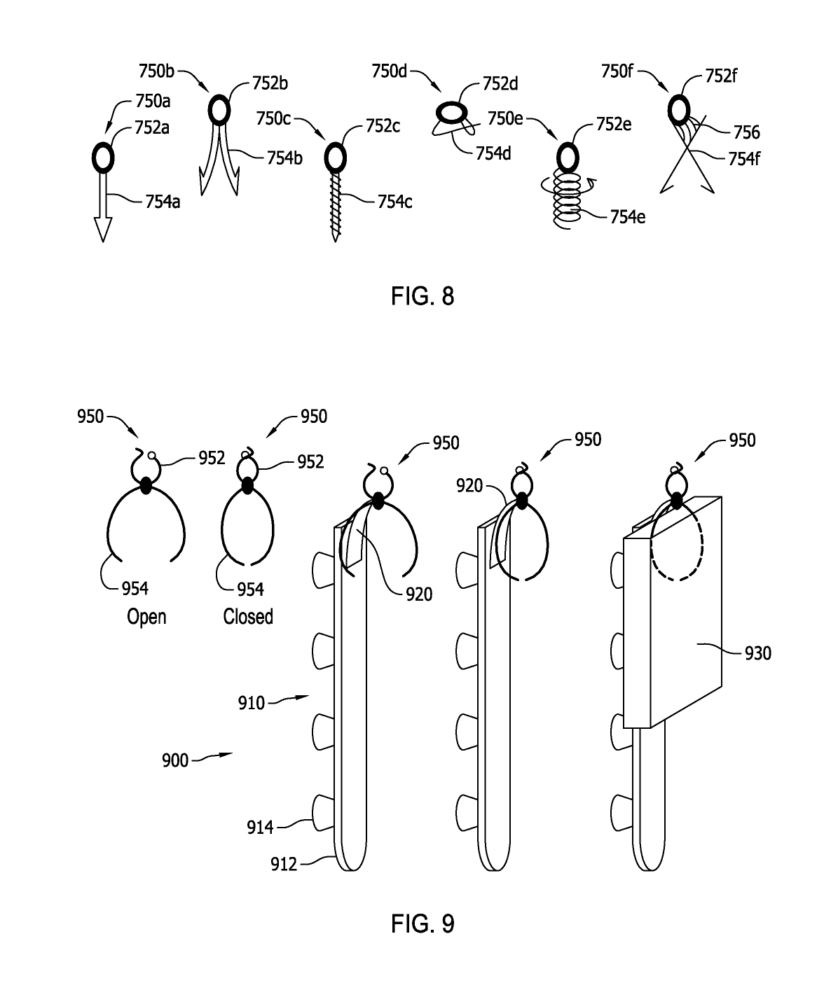

FIG. 8 shows modification tools for modifying a sponge for use with the sponge holder shown in FIG. 6. The modification tools 750a-750f each include a head 752a-752f that is configured as a ring to receive the suspension rod 622 of the sponge holder 600. Each of the modification tools further includes a body 754a-754f that is configured to be inserted into the sponge 730. Each body 754a-754f is also configured to fix the modification tool 750a-750f to the sponge 730. The bodies 754a-754f are substantially similar to those of modification tools 550a-550f and 250-250e, and a description thereof will be omitted.

FIG. 9 shows an alternative sponge holder, modification tool, and sponge according to an exemplary embodiment of the invention. The sponge holder 900 includes a sponge mount 910 having a mounting fixture 912 and mounting connectors 914. The sponge holder 900 also includes a suspension arm 920.

In this embodiment, an alternative modification tool 950 is shown that does not need to be inserted into a sponge. The modification tool 950 is constructed as a clamp with actuators 952 that are configured to connect to one another in the closed configuration and jaws 954 configured to grip an outer surface of a sponge 930. The modification tool 950 is adapted to removably attach to the suspension arm 920. Alternatively, the modification tool 950 may be permanently affixed to the end of the suspension arm 920.

In use, the sponge 930 may be suspended from the end of the suspension arm 920 via the modification tool 950. Specifically, the jaws 954 are moved from an open to a closed position surrounding the sponge 930 to hold the sponge in place. The actuators 952 may be locked into the closed position. The modification tool 950 is suspended from the suspension arm 920. In this manner, contamination of the sponge 930 may be prevented, and the practical life of the sponge 930 may be extended.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A kit for holding a sponge comprising:
a sponge holder comprising
a mount having a mounting fixture and at least one mounting connector, the at least one mounting connector being configured to fix the mount to a surface,
a suspension arm extending from the mounting fixture, and
an adapter connector disposed at a distal end of the suspension arm; and
an adapter configured to connect to a sponge and the adapter being configured to connect to the adapter connector of the sponge holder to suspend the sponge below the suspension arm while not contacting the surface.

2. The kit according to claim 1, wherein the connector comprises a magnet housing that includes a magnet and the magnet housing is configured to allow the magnet to rotate therein.

3. The kit according to claim 2, wherein the adapter comprises magnetic material, and the sponge is connected to the sponge holder by a magnetic field between the magnet and the magnetic material.

4. The kit according to claim 3, wherein the magnetic material is embedded inside of the sponge.

5. The kit according to claim 3, wherein the adapter is a sponge modification tool, the modification tool including a head that comprises the magnetic material and a body that is configured to be inserted into the sponge and to be retained within the sponge.

6. The kit according to claim 1, wherein the connector comprises a first side of a hook and loop fastener.

7. The kit according to claim 6, wherein the adapter is a second side the hook and loop fastener and the adapter is disposed on an outer side surface of the sponge.

8. The kit according to claim 6, wherein the adapter is a sponge modification tool, the modification tool including a head that comprises a second side of the hook and loop fastener and a body that is configured to be inserted into the sponge and to be retained within the sponge.

9. The kit according to claim 1, wherein the connector comprises a suspension rod that extends substantially horizontally.

10. The kit according to claim 9, wherein the adapter is an aperture that extends through the sponge, and the suspension rod is configured to extend through the aperture, thereby suspending the sponge from the connector.

11. The kit according to claim 9, wherein the adapter is a sponge modification tool, the modification tool including a head that forms a ring, the suspension rod being configured to extend through the ring, and a body that is configured to be inserted into the sponge and to be retained within the sponge.

10. A suspension tool holder for holding and suspending a tool comprising:
a mount having a mounting fixture and at least one mounting connector, the mounting connector being configured to attach the mount to a surface;
a suspension arm having a proximal end and a distal end, the proximal end attached to and extending from the mounting fixture, the suspension arm being having a length which provides clearance between the mounting fixture and the tool when the tool is suspended from the suspension arm; and
an adaptor connector attached to the distal end of the suspension arm, the adaptor connector configured to releasably connect with an adapter, the adapter secured to the tool to allow the tool to be suspended from the suspension arm due to the connection between the adaptor connector and the adapter.

11. The suspension tool holder according to claim 10, wherein the tool is a sponge, the adapter connector is a magnet housing that includes a magnet, and the adapter is a magnetic material embedded within the sponge.

12. The suspension tool holder according to claim 10, wherein the adaptor connector is a magnet housing that includes a magnet, and the adapter includes a magnetic head and a body that secures the body and head to the sponge.

13. The suspension tool holder according to claim 10, wherein the adaptor connector is a first side of a hook and loop fastener and the adapter includes a second side of the hook and loop fastener.

14. The suspension tool holder according to claim 10, wherein the adaptor connector includes rod that extends generally horizontally, and at least part of the adapter forms a ring shape through which the rod is configured to extend.

15. A holder configured to suspend a cleaning tool, the holder comprising:
a mount having a mounting fixture and at least one mounting connector, the at least one mounting connector being configured to fix the mount to a surface,
a suspension arm extending from the mounting fixture, and
a connector disposed at a distal end of the suspension arm;
the connector including actuators and jaws, the actuators being configured open and close the jaws and being lockable in the closed position, and the jaws being configured to grip a cleaning tool, thereby suspending the cleaning tool from the jaws.

16. The sponge holder according to claim 15, wherein the suspension arm is configured to extend from the mounting fixture so as to provide clearance between the cleaning tool and the mounting fixture.

17. The sponge holder according to claim 15, wherein the connector is selectively removable from the suspension arm.

18. The sponge holder according to claim 15, wherein the cleaning tool is selected from the group of cleaning tools including a sponge, scouring pad, cloth, and a cleaning tool that is a combination of two or more of these cleaning tools.
